(19) United States
(12) Patent Application Publication
(10) Pub. No.: US 2007/0193304 A1
(43) Pub. Date: Aug. 23, 2007

(54) Glass molding die

(75) Inventors: Hiroki Itakura, Kitanagoya-shi (JP); Ryo Minoshima, Kasugai-shi (JP)

Correspondence Address: OLIFF & BERRIDGE, PLC, P.O. BOX 19928, ALEXANDRIA, VA, 22320, US

(73) Assignee: TOKAI RUBBER INDUSTRIES, LTD., KOMAKI-SHI (JP)

(21) Appl. No.: 11/703,157

(22) Filed: Feb. 7, 2007

(30) Foreign Application Priority Data
Feb. 23, 2006 (JP) 2006-046857
Nov. 24, 2006 (JP) 2006-316578

(51) Int. Cl. C03B 11/00; A21C 11/00; C03B 23/00; B28B 7/36; C03B 9/48

(52) U.S. Cl. 65/66; 65/374.12; 65/102; 249/116; 425/394

(57) ABSTRACT

To provide a glass molding die which is more excellent in durability than the conventional ones. A glass molding die 10 includes a base body 12, an Au layer 14 which is laminated on a surface of the base body 12, and an Rh layer 16 which is laminated on a surface of the Au layer 14. On a surface of the Rh layer 16, an Ir-containing layer may be further laminated. The Au layer 14 functions as a bonding layer, the Rh layer 16 functions as an anti diffusion layer, and the Ir-containing layer functions as a mold releasing layer. The Au layer 14, the Rh layer 16, and the Ir-containing layer are preferably formed by plating.

### BACKGROUND OP THE INVENTION

1. Field of the Invention

The present invention relates to a glass molding die.

2. Description of Related Art

Conventionally, there is known a glass molding die, a base material of which is coated with an anti diffusion film and a mold releasing film in this order.

For example, disclosed in Japanese Patent Application Unexamined Publication No. 2002-60239 (see Example and the like) is a glass molding die in which a base material consisting of WC is coated with an anti diffusion film including Nb, Hf and Ta which is formed by a sputtering method, and a mold releasing film including an Ir—Pt alloy and an Ir—Re alloy which is formed by the sputtering method, in this order.

However, the conventionally known glass molding dies have a problem of low durability such as peeling-off of the anti diffusion film during production of a glass molded product. Because of this, the glass molding dies have a short life span and are difficult to find use in the actual production.

In addition, once the anti diffusion film peels off, ingredients of the base material cannot be prevented from diffusing. As a result, the glass molded product is apt to be contaminated by the base material ingredients, and glass and the molding die are apt to fuse with and adhere to each other to cause a difficulty in molding.

As described above, the conventional glass molding dies are apt to cause various problems due to their low durability.

### SUMMARY OF THE INVENTION

An object of the invention is to overcome the problems described above and to provide a glass molding die which is more excellent in durability than the conventional ones.

To achieve the objects and in accordance with the purpose of the present invention, a glass molding die consistent with the present invention includes a base body, an Au layer which is laminated on a surface of the base body, and an Rh layer which is laminated on a surface of the Au layer.

Here, it is preferable that the Au layer and/or the Rh layer are formed by plating.

In addition, it is preferable that an Ir-containing layer is further laminated on a surface of the Rh layer. The Ir-containing layer is preferably an Ir—Re layer.

In addition, it is preferable that the Ir-containing layer is formed by plating.

Meanwhile, a glass molded product consistent with the present invention is molded by the use of the glass molding die.

In addition, a production process of the glass molded product consistent with the present invention includes a step of molding a glass material by the use of the glass molding die.

In the glass molding die, the Rh layer is laminated on the surface of the base body via the Au layer.

Here, the Au layer functions mainly as a bonding layer for boning the base body and the Rh layer. In addition, the Rh layer functions mainly as an anti diffusion layer for preventing ingredients of the base body and the Au layer from diffusing.

The Rh layer hardly peels off owing to the presence of the Au layer, so that the glass molding die is excellent in durability compared with conventional ones. Therefore, by the use of the glass molding die consistent with the present invention, an increase in longevity of the glass molding die can be achieved.

In addition, since the Rh layer hardly peels off, the glass molded product is hard to be contaminated by the base body ingredients. Further, the diffusion of the ingredients of the layers lower than the Rh layer can be prevented over a long period of time, so that the glass and the molding die are hard to fuse with and adhere to each other to increase productivity.

Here, when the Au layer and/or the Rh layer are formed by plating, selecting plating conditions as appropriate facilitates planarization of a surface of the molding die. Therefore, a glass molded product with little surface asperities is easy to obtain.

In addition, when the Ir-containing layer is further laminated on the surface of the Rh layer, the Ir-containing layer mainly functions as a mold releasing layer. Therefore, the glass molded product is easy to release from the molding die.

Especially when the Ir-containing layer is the Ir—Re layer, durability increases easily.

In addition, when the Ir-containing layer is formed by plating, a glass molded product with little surface asperities is easy to obtain similarly to the above.

Meanwhile, being molded by the use of the glass molding die, the glass molded product consistent with the present invention is excellent in manufacturability and the like.

In addition, the production process of the glass molded product includes the step of molding the glass material by the use of the glass molding die, which can facilitate glass molding and decrease the number of molding-die changes which are needed due to a life span of the dies; therefore, the glass molded product is excellent in manufacturability.

Additional objects and advantages of the invention are set forth in the description which follows, are obvious from the description, or may be learned by practicing the invention. The objects and advantages of the invention maybe realized and attained by the glass molding die in the claims.

### BRIEF DESCRIPTION OP THE DRAWINGS

The accompanying drawings, which are incorporated in and constitute a part of this specification, illustrate embodiments of the present invention and, together with the description, serve to explain the objects, advantages and principles of the invention. In the drawings,

FIG. 1 is a sectional view showing an example of basic configuration of a glass molding die consistent with the preferred embodiment of the present invention;

FIG. 2 is a sectional view showing another configuration of the glass molding die of FIG. 1 where an Ir-containing layer is further laminated; and

FIGS. 3A to 3C are views for illustrating a difference in states of surface asperities of Au layers formed by vapor deposition and a plating method.

### DETAILED DESCRIPTION OF THE PREFERRED EMBODIMENTS

Detailed description of one preferred embodiment of a glass molding die embodied by the present invention is provided below.

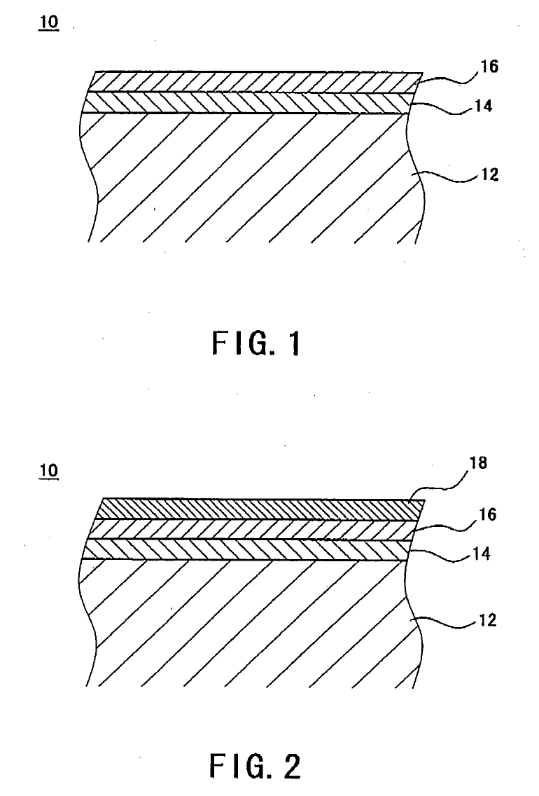

Firstly, description is given to configuration of the molding die. As shown in FIG. 1, a glass molding die 10 includes a base body 12, an Au layer 14, and an Rh layer 16 as basic configuration.

The base body 12 is a main body of the molding die. On a surface of the base body 12, a transcriptional surface (unillustrated) to transcribe a desired shape onto a molding material is usually formed. The Au layer 14 lies between the base body 12 and the Rh layer 16, and mainly has a function of bonding them. The Rh layer 16 is formed on a surface of the Au layer, and mainly has a function of preventing ingredients of the lower layers from diffusing.

In the molding die, the Au layer may be formed in one layer, or in two or more separate layers. Additionally, when the Au layer is formed in separate layers, the respective layers may have the same composition, or may have different composition. The same goes for the Rh layer.

In the molding die, it is enough for the Rh layer to be able to prevent diffusion of at least one ingredient having an adverse effect on mold ability or reducing commercial value of a molded product when adhering thereto/being mixed therein, among the ingredients of the base body and the Au layer.

Such an ingredient includes Ti, Cr, Fe, Co, Ni, Ta, W and the like.

In the molding die, a material for the base body is not limited particularly. From the viewpoint of gaining a sufficient bonding force between the base body and the Au layer, such a material that has a Vickers hardness within 200 to 2100 measured in accordance with JIS Z 2244 can be favorably used.

As the above-described material for the base body, specifically cited are a WC base cemented carbide, glassy carbon, stainless steel, ceramics including Si and a complex thereof, and the like, Among these, the WC base cemented carbide, the ceramics and the like are preferable from the viewpoint of excellent durability, heat resistance and the like.

In the molding die, it is preferable that the Au layer is at a purity greater than 2N (99%), and more preferably greater than 3N (99.9%) fromthe viewpoint ofexcellent mechanical strength and the like.

In addition, it is preferable that the Rh layer is at a purity greater than 2N (99%), and more preferably greater than 3N (99.9%) from the viewpoint of excellent antidiffusion effect.

In the molding die, it is preferable that a thickness of the Au layer has certain limits. This is because a tendency to decrease in mechanical strength is observed if the Au layer increases excessively in thickness, and a tendency to decrease in bonding force is observed if the Au layer is reduced excessively in thickness.

For the limits of the thickness of the Au layer, a preferable upper limit is 0.1 μm, 0.05 μm, 0.03 μm or the like, and a preferable lower limit suitably used in combination with the preferable upper limit is 0.01 μm or the like.

In addition, it is preferable that a thickness of the Rh layer has certain limits. This is because there is a case where surface asperities on the molding die develop to make it difficult to obtain a molded product with a fine surface if the Rh layer increases excessively in thickness, and a tendency to lessen the anti diffusion effect is observed if the Rh layer is reduced excessively in thickness.

For the limits of the thickness of the Rh layer, a preferable upper limit is 1 μm, 0.5 μm or the like, and a preferable lower limit suitably used in combination with the preferable upper limit is 0.2 μm, 0.3 μm or the like.

In the molding die, it is preferable that a particle size of the Au layer has certain limits. This is because a tendency to decrease in mechanical strength is observed if the particles of the Au layer increase excessively in size, while if the particles of the Au layer decrease excessively in size, they increase excessively in number and a tendency to increase a void part in the layer is observed, making the layer brittle.

For the limits of the particle size of the Au layer, a preferable upper limit is 1000 nm, 500 nm, 100 nm or the like, and a preferable lower limit suitably used in combination with the preferable upper limit is 1 nm, 5 nm, 10 nm, 50 nm or the like.

In addition, it is preferable that a particle size of the Rh layer has certain limits. This is because a tendency to decrease in mechanical strength is observed if the particles of the Rh layer increase excessively in size, while if the particles of the Rh layer decrease excessively in size, they increase excessively in number and a tendency to increase a void part in the layer is observed, making the layer brittle.

For the particle size of the Rh layer, a preferable upper limit is 500 nm, 120 nm, 110 nm, 100 nm, 90 nm or the like, and a preferable lower limit suitably used in combination with the preferable upper limit is 1 nm, 5 nm, 7.5 nm, 10 nm, 12.5 nm, 15 nm or the like.

In the above, a case where the molding die includes the Rh layer as the outermost layer is described. In addition to this, the molding die may further include an Ir-containing layer 18 on a surface of the Rh layer 16 as shown in FIG. 2.

The Ir-containing layer mainly has a function of promoting releasing the molding die from a glass molded product. A decision as to whether or not to laminate the Ir-containing layer can be made as necessary in consideration of molding conditions such as the type and a molding temperature of a glass material.

In other words, under some molding conditions, lamination up to the Rh layer bears no problem in releasing the molding die, and in such a case, there is no need to laminate the Ir-containing layer purposely. On the other hand, when molding is performed at high temperatures not less than 450° C. as an example, the glass molded product is sometimes difficult to release from the molding die, and in such a case, it is better to further laminate the Ir-containing layer.

The above-described Ir-containing layer may be formed in one layer, or in two or more separate layers. When the Ir-containing layer is formed in separate layers, the respective layers may have the same composition, or may have different composition.

The above-described Ir-containing layer contains Ir and/or an Ir alloy. When the Ir alloy is contained, Pt, Pd, Rh, Ru, Re and the like are specifically cited as alloy elements other than Ir. These elements may be contained by one sort or more than one sort.

In addition, the Ir-containing layer may contain a metal and/or an alloy other than Ir and/or the Ir alloy as long as it exhibits the mold releasing property. As the metal and/or the alloy other than Ir and/or the Ir alloy, specifically cited are Pt, a Pt alloy, Pd, a Pd alloy and the like. These may be contained by one sort or more than one sort.

As the Ir-containing layer, specifically cited are an Ir layer, an Ir—Pt layer, an Ir—Re layer and the like from the viewpoint of excellence in the mold releasing property. The Ir—Re layer is preferable from the viewpoint of its capability of easily improving durability.

In addition, a thickness of the Ir-containing layer is not specifically limited and may be selected as appropriate in consideration of the mold releasing property and the like.

For the thickness of the Ir-containing layer, a preferable upper limit is 1 μm, 0.5 μm or the like, and a preferable lower limit suitably used in combination with the preferable upper limit is 0.1 μm, 0.2 μm or the like.

Incidentally, the molding die may include a diamond-like carbon (OLC) layer in place of or in combination with the Ir-containing layer.

A glass material which is to be molded using the molding die is not limited particularly and may be any glass material. Specifically cited are a boric oxide silicate glass and the like which need to be molded at high temperatures.

As a glass molded product which is molded using the molding die, specifically cited are the ones for a wide variety of uses, for example, an optical element such as a glass lens, and a glass substrate and a glass element employed in the field of optical communications.

In addition, the molded product can be obtained by subjecting the glass material to a process of molding through various molding methods such as press molding and injection molding with the use of the glass molding die.

Next, description is given to an example of a production process of the molding die.

The production process includes steps of laminating the Au layer on the surface of the base body, and laminating the Rh layer on the surface of the Au layer.

Incidentally, before laminating the Au layer on the surface of the base body, pretreatment such as degreasing treatment, removal of a passivation film, and cleansing may be provided as necessary.

Here, the Au layer and the Rh layer can be laminated on the surface of the base body by various methods.

As a method for forming the Au layer and the Rh layer, specifically cited are vapor deposition including physical vapor deposition (PVD) such as a sputtering method, a vacuum deposition method, an ion plating method, an MBE method and laser ablation, and chemical vapor deposition (CVD) such as thermal CVD and plasma CVD, and a liquid phase method including a plating method such as electrolytic plating and electroless plating, anodic oxidation coating, a coating method, and a sol-gel method. Besides, the Au layer and the Rh layer may be formed by the same method, or by the different methods.

It is favorable for the Au layer and the Rh layer to be formed by the plating method especially from the viewpoint of easy planarization of the molding die surface, and low cost compared with the vapor deposition.

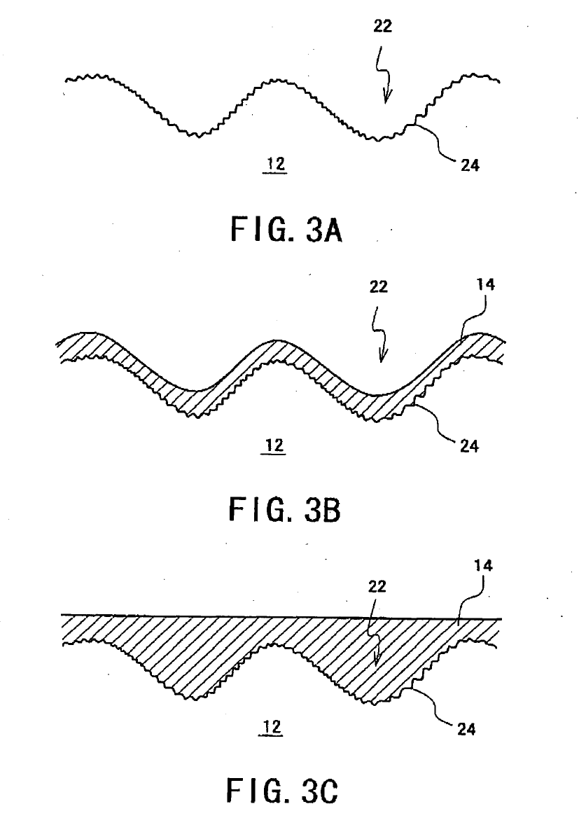

FIGS. 3A to 3C are views for illustrating a difference in states of surface asperities of the Au layers formed by the vapor deposition and the plating method. In FIG. 3A, the Au layer is not formed yet. FIG. 3B shows a case where the Au layer is formed by the vapor deposition, and FIG. 3C shows a case where the Au layer is formed by the plating method.

As shown in FIG. 3A, the base body 12 before the AU layer 14 is formed thereon usually gives a relatively large asperity part 22 and a relatively small asperity part 24 on its surface. For example, the relatively large asperity part 22 is formed by a mark which was made in machining the molding die.

Meanwhile, for example, the relatively small asperity part 24 is formed by particles which dropped off in machining the molding die, and pores which are present on the surface of the base body.

When the Au layer 14 is formed by the vapor deposition on the surface of the base body 12 in the state shown in FIG. 3A, the relatively small asperity part 24 is planarized while the relatively large asperity part 22 is difficult to be planarized as shown in FIG. 3B.

On the other hand, when the Au layer 14 is formed by the plating method, both of the relatively small asperity part 24 and the relatively large asperity part 22 are easy to be planarized as shown in FIG. 3C.

Therefore, there is an advantage of easily obtaining a molded product with less surface asperities. The same goes for cases where the Rh layer is formed on the surface of the Au layer and where the Ir-containing layer is further formed on the surface of the Rh layer.

When employing the plating method, plating conditions such as the type of plating liquid, a current density of plating, plating time, a temperature for plating bathing, and the type and quantity of additive for providing a planarizing property which is added during the plating bathing can be adjusted as appropriate.

For example, for the current density of plating and the plating time, it is favorable to select a relatively high current density of plating and short plating time in order not to reduce mechanical strength by coarsening of precipitated particles of the plating, while depending on the type of the plating liquid.

For the current density of plating of the Au layer, a preferable upper limit is 6 A/dm², 5 A/dm² or the like, and a preferable lower limit suitably used in combination with the preferable upper limit is 0.1 A/dm², 0.2 A/dm² or the like.

In addition, it is essential only to adjust the plating time as appropriate in accordance with the current density of plating, and it is preferably within 60 seconds, more preferably within 30 seconds, and still more preferably within 10 seconds.

Meanwhile, for the current density of plating of the Rh layer, a preferable upper limit is 6 A/dm², 5 A/dm² or the like, and a preferable lower limit suitably used in combination with the preferable upper limit is 0.1 A/dm²₁, 0.2 A/dm² or the like.

In addition, it is essential only to adjust the plating time as appropriate in accordance with the current density of plating, and it is preferably within 30 minutes, more preferably within 2 minutes, and still more preferably within 1 minute.

When employing the plating method in forming the AU layer and/or the Rh layer, annealing treatment or the like may be provided to the formed plated layers. Providing the annealing treatment can effectively prevent the diffusion of the ingredients resulting from a pinhole or the like.

Incidentally, the production process may further include a step of laminating the Ir-containing layer on the surface of the Rh layer as necessary. In this case, the Ir-containing layer can be laminated by the various methods same as the Au layer and the Rh layer, preferably by the plating method.

### EXAMPLES

Hereinafter, detailed description on the present invention will be given referring to Examples.

### 1. Preparation of Base Body and Pretreatment Provided to Surface thereof

As the base body, a-sintered compact made by sintering a tungsten carbide powder containing 12 wt % Co wasprepared. Besides, the base body contained 1000 ppm or less of Fe, Ni, and Cr as impurity ingredients.

Next, the surface of the base body which was sintered into a predetermined shape was subjected to anodic electrolytic treatment and degreasing treatment using an NaOH aqueous solution, and organic impurities present on the surface were dissolved. Then, the base body was soaked in a solution of 60 ml/L containing EDTA (70 g/L) and a hydrogen peroxide solution (35 wt %) to remove a passivation film present on the surface of the base body. Further, the surface of the base body was cleansed with hydrochloric acid and then with water.

### 2. Formation of Bonding Layer

### 2.1 Forming Method 1

Using a gold strike plating bath (manuf.: Electroplating Engineers of Japan Ltd., trade name: “Neutronex Strike”), an Au layer consisting of Au strike plating was formed on the surface of the base body which was subjected to the pretreatment under conditions of a current density of plating of 3 A/dm² and a temperature for plating bathing of 50° C.

Here, plating time of Examples 1, 3, 4 and 5 was set as 25 seconds each.

### 2.2 Forming Method 2

An Au layer was formed by the sputtering method on the surface of the base body.

### 2.3 Forming Method 3

An Nb layer was formed by the sputtering method on the surface of the base body.

### 3. Formation of Anti Diffusion Layer

### 3.1 Forming Method 1

Using plating liquid containing 80 g/L of Rh₂(SO₄)₃ and 180 g/L of sulfuric acid, an Rh layer consisting of Rh plating was formed on a surface of the bonding layer under conditions of a current density of plating of 1.3 A/dm², plating time of 2.5 minutes, and a temperature for plating bathing of 45° C.

### 4. Formation of Mold Releasing Layer

### 4.1 Forming Method 1

Using plating liquid containing 8 g/L of (NH₄)₂IrCl₆ and 0.8 g/L of sulfuric acid, an Ir layer consisting of Ir plating was formed on a surface of the anti diffusion layer under conditions of a current density of plating of 1.0 A/dm², plating time of 5 minutes, and a temperature for plating bathing of 50C.

### 4.2 Forming Method 2

An Ir—Pt layer consisting of an Ir—Pt alloy (Ir: 50 wt %, Pt: 50 wt %) was formed by the sputtering method on the surface of the anti diffusion layer.

### 4.3 Forming Method 3

An Ir—Re layer consisting of an Ir—Re alloy (Ir: 50 wt %, Re: 50 wt %) was formed by the sputtering method on the surface of the anti diffusion layer.

### 5. Hardness Measurement of Bonding Layer and Anti Diffusion Layer

Hardnesses of the bonding layer and the anti diffusion layer were measured by carrying out a Vickers hardness measurement (in accordance with JIS Z 2244) on the layers which were formed in about 1 μm on a copper plate. Here, as a hardness tester, “Nano Hardness Tester NHT” manufactured by Nanotec Corporation was used. Incidentally, a Vickers hardness of the base body was also measured (in accordance with JIS Z 2244) to obtain 2040 (HV).

### 6. Thickness Measurement of Bonding Layer, Anti Diffusion Layer and Mold Releasing Layer

By observing the bonding layer, the anti diffusion layer and the mold releasing layer under an SIM (scanning ion microscope) after providing etching to them by the use of a focused ion beam (FIB) system (manuf.: FEI Inc., trade name: “FIB 200”), thicknesses thereof were measured. Besides, the thicknesses in Table 1 to be described later denote an average value of thicknesses which were measured at five randomly-chosen points in a center part of a specimen.

### 7. Average Particle Size Measurement of Bonding Layer and Anti Diffusion Layer

By observing the bonding layer and the anti diffusion layer under the SIM after providing etching to them by the use of the above-described focused ion beam (FIB) system, average particle sizes thereof were measured. Besides, the average particle sizes in Table 1 to be described later denote an average value of particle sizes which were measured for ten randomly-chosen particles in the center part of the specimen.

### 8. Durability Assessment

Durability assessments were made as to glass molding dies consistent with the Examples and Comparative Examples shown in Table 1 to be described later. To be specific, a cycle of keeping the glass molding dies at 800° C. in an Ar atmosphere for 1 hour, and then leaving them to cool as low as 100° C. was repeated 20 times.

Next, in accordance with a grid adhesion test stipulated by JIS D0202-1988, an adhesive tape (manuf.; NICHIBAN CO., LTD., trade name: “CT24”) was stuck fast on the respective outermost surfaces of the glass molding dies, and then peeled away.

Here, the glass molding die of which the number of peeled-off sections among 100 sections was less than 50 was regarded as passed. Besides, in Table 2 to be described later, “X/100” (where X is an integer of 0 to 100) means that peeling-off of the function layers was observed in X sections among 100 sections.

### 9. Anti Diffusion Effect Assessment

Assessments on anti diffusion effect were made as to the glass molding dies consistent with the Examples and the Comparative Examples shown in Table 1 to be described later. To be specific, the glass molding dies were kept at 800° C. in the Ar atmosphere for 100 hours, and then left cool to reach room temperatures.

Next, by Auger spectroscopy, presence of W, Co, Fe, Ni, Cr, or Au, which are ingredients having a potential for diffusing from the lower layers, on the surface layer (the anti diffusion layer or the mold releasing layer) was checked. Besides, as an ingredient detector, “Scanning Auger Microscope PH1700” manufactured by ULVAC-PHI, INCORPORATED was used.

Here, the glass molding die in which ingredients other than the ingredients of the surface layer were not present or ingredients other than the ingredients of the surface layer were present at 15 atom % or less was regarded as passed judging that the diffusion of the lower-layer ingredients was prevented. On the other hand, the glass molding die in which ingredients other than the ingredients of the surface layer were present at more than 15 atom % was regarded as failed judging that the diffusion of the lower-layer ingredients was observed.

Table 1 provides a summary of compositions, Vickers hardnesses, thicknesses, average particle sizes and the like of the respective layers formed on the surfaces of the base bodies with respect to the glass molding dies consistent with the Examples and the Comparative Examples. In addition, Table 2 provides a summary of assessment results of the glass molding dies consistent with the Examples and the Comparative Examples. Besides, in Table 2, the glass molding dies of which both the assessments on durability and anti diffusion effect were regarded as passed were regarded as passed in comprehensive assessment.

TABLE 1

| | Bonding Layer | | | | | Antidiffusion Layer | | | | |
|---|---|---|---|---|---|---|---|---|---|---|
| | | | Vickers | | Average | | | Vickers | | Average |
| | | Forming | Hardness | Thickness | Particle | | Forming | Hardness | Thickness | Particle |
| | Composition | Method No. | (Hv) | (μm) | Size (nm) | Composition | Method No. | (Hv) | (μm) | Size (nm) |
| Example 1 | Au | 1 | 40 | 0.05 | 150 | Rh | 1 | 900 | 0.2 | 15 |
| Example 2 | Au | 2 | 35 | 0.05 | 200 | Rh | 1 | 900 | 0.2 | 15 |
| Example 3 | Au | 1 | 40 | 0.05 | 150 | Rh | 1 | 900 | 0.2 | 15 |
| Example 4 | Au | 1 | 40 | 0.05 | 150 | Rh | 1 | 900 | 0.2 | 15 |
| Example 5 | Au | 1 | 40 | 0.05 | 150 | Rh | 1 | 900 | 0.2 | 15 |
| Comparative | No Bonding Layer | | | | | Rh | 1 | 900 | 0.2 | 15 |
| Example 1 | | | | | | | | | | |
| Comparative | Nb | 3 | 720 | 0.4 | 90 | Rh | 1 | 900 | 0.2 | 15 |
| Example 2 | | | | | | | | | | |

| | | | | | | |
|---|---|---|---|---|---|---|
| Comparative | Au | 1 | 40 | 0.05 | 150 | No Antidiffusion Layer |
| Example 3 | | | | | | |

| | Mold Releasing Layer | | |
|---|---|---|---|
| | | Forming | Thickness |
| | Composition | Method No. | (μm) |
| Example 1 | No Mold Releasing Layer | | |
| Example 2 | No Mold Releasing Layer | | |
| Example 3 | Ir | 1 | 0.5 |
| Example 4 | Ir—Pt | 2 | 0.5 |
| Example 5 | Ir—Re | 3 | 0.5 |
| Comparative | Ir | 1 | 0.5 |
| Example 1 | | | |
| Comparative | No Mold Releasing Layer | | |
| Example 2 | | | |
| Comparative | Ir | 1 | 0.5 |
| Example 3 | | | |

TABLE 2

| | | | | | Comprehensive |
|---|---|---|---|---|---|
| | Durability | Passed/ | Antidiffusion Effect | Passed/ | Assessment |
| | Assessment | Failed | Assessment | Failed | Passed/Failed |
| Example 1 | 0/100 | Passed | Ingredients other than | Passed | Passed |
| | | | Rh were not present | | |
| Example 2 | 0/100 | Passed | Ingredients other than | Passed | Passed |
| | | | Rh were not present | | |
| Example 3 | 0/100 | Passed | Ingredients other than | Passed | Passed |
| | | | Ir were not present | | |
| Example 4 | 0/100 | Passed | Ingredients other than | Passed | Passed |
| | | | Ir/Pt were not present | | |
| Example 5 | 0/100 | Passed | Ingredients other than | Passed | Passed |
| | | | Ir/Re were not present | | |
| Comparative | 100/100 | Failed | Ingredients other than | Passed | Failed |
| Example 1 | | | Ir were not present | | |
| Comparative | 100/100 | Failed | Ingredients other than | Passed | Failed |
| Example 2 | | | Rh were not present | | |
| Comparative | 30/100 | Passed | Ir was present at 50 atom % and | Failed | Failed |
| Example 3 | | | Co was present at 30 atom % | | |

According to Table 1 and Table 2, the following conclusions are made; peeling-off of the Rh layer and the Ir-containing layer was observed in the glass molding die consistent with the Comparative Example 1 in which the Rh layer was laminated on the surface of the base body with no Au layer therebetween, and in the glass molding die consistent with the Comparative Example 2 in which the Nb layer was employed in place of the Au layer, and thereby durability was considerably low.

In addition, in the glass molding die consistent with the Comparative Example 3 in which no Rh layer was formed, the diffusion of the lower-layer ingredients was not sufficiently prevented.

On the other hand, in the glass molding dies consistent with the Examples, the Rh layers were laminated on the surfaces of the base bodies with the Au layers therebetween, and the Rh layers hardly peeled off owing to the presence of the Au layers; accordingly, durability was excellent.

In addition, in the glass molding dies consistent with the Examples, the diffusion of the lower-layer ingredients was effectively prevented by the Rh layer.

### 10. Manufacturability, Assessment of Glass Molded Product

Next, manufacturability assessments of glass molded products were made by actually press molding the glass materials by the use of the glass molding dies consistent with the Example 4 and the Example 5.

To be specific, the glass molding dies subject to the assessment were placed in a glass element vacuum forming machine (manuf.: TOSHIBA MACHINE CO., LTD., trade name: “GMP-207HV”), and the glass molded products were manufactured by repeating a molding cycle of press molding a glass material (manuf. OHARA INC., trade name: “Optical Glass S-BSL7”) at 700° C., cooling down to 200° C., and taking out glass.

Then, then umber of cycles before the manufactured glass molded product could not be taken out normally from the molding die was counted.

As a result, the number of cycles for the glass molding die consistent with the Example 4 was 100, and the number of cycles for the glass molding die consistent with the Example 5 was 200 or more, being double or more of the Example 4.

Accordingly, it was shown that Selecting the Ir—Re layer as the Ir-containing layer being the mold releasing layer could further increase durability, especially durability at high temperatures.

The foregoing description of the preferred embodiments and the molding dies consistent with the Examples has been presented for purposes of illustration and description, It is not intended to be exhaustive or to limit the invention to the precise form disclosed, and modifications and variations are possible in the light of the above teachings or may be acquired from practice of the invention. The embodiments chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A glass molding die comprising:
a base body;
an Au layer which is laminated on a surface of the base body; and
an Rh layer which is laminated on a surface of the Au layer.

2. The glass molding die according to claim 1, wherein at least one of the Au layer and the Rh layer is formed by plating.

3. The glass molding die according to claim 2, further comprising an Ir-containing layer laminated on a surface of the Rh layer.

4. The glass molding die according to claim 3, wherein the Ir-containing layer is an Ir—Re layer.

5. The glass molding die according to claim 4, wherein the Ir-containing layer is formed by plating.

6. The glass molding die according to claim 3, wherein the Ir-containing layer is formed by plating.

7. A glass molded product which is molded by the use of the glass molding die according to claim 3.

8. A production process of a glass molded product comprising a step of molding a glass material by the use of the glass molding die according to claim 3.

9. A glass molded product which is molded by the use of the glass molding die according to claim 2.

10. A production process of a glass molded product comprising a step of molding a glass material by the use of the glass molding die according to claim 2.

11. The glass molding die according to claim 1, further comprising an Ir-containing layer laminated on a surface of the Rh layer.

12. The glass molding die according to claim 11, wherein the Ir-containing layer is an Ir—Re layer.

13. The glass molding die according to claim 12, wherein the Ir-containing layer is formed by plating.

14. A glass molded product which is molded by the use of the glass molding die according to claim 12.

15. A production process of a glass molded product comprising a step of molding a glass material by the use of the glass molding die according to claim 12.

16. The glass molding die according to claim 11, wherein the Ir-containing layer is formed by plating.

17. A glass molded product which is molded by the use of the glass molding die according to claim 11.

18. A production process of a glass molded product comprising a step of molding a glass material by the use of the glass molding die according to claim 11.

19. A glass molded product which is molded by the use of the glass-molding die according to claim 1.

20. A production process of a glass molded product comprising a step of molding a glass material by the use of the glass molding die according to claim 1.
